(19) United States
(12) Patent Application Publication
(10) Pub. No.: US 2026/0295743 A1
(43) Pub. Date: Oct. 1, 2026

(54) WORKPIECE FRAME CLAMP FOR MACHINE FIXTURES

(71) Applicant: Rolls-Royce Corporation, Indianapolis, IN (US)

(72) Inventor: Rusty Garner, Indianapolis, IN (US)

(21) Appl. No.: 19/092,584

(22) Filed: Mar. 27, 2025

(51) Int. Cl. B23Q 3/06

(52) U.S. Cl. CPC B23Q 3/065

(57) ABSTRACT

A machine tool system includes a workpiece, a machine, and a workpiece frame. The workpiece frame is repositionable and relocatable on the machine in at least two different orientations to support the workpiece in the at least two different orientations during modification of the workpiece so that different sides of the workpiece are modified without requiring removal of the workpiece from the workpiece frame.

### FIELD OF THE DISCLOSURE

The present disclosure relates generally to machine tool systems, and more specifically to workpiece frames of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

A machine tool system may comprise a thin-walled three-dimensional workpiece, a machine, and a workpiece frame. The machine may be configured to modify the thin-walled three-dimensional workpiece. The machine may include a tool base configured to support the thin-walled three-dimensional workpiece and a shaft spaced apart from the tool base along a first axis and configured to move along the first axis relative to the tool base to modify the thin-walled three-dimensional workpiece. The workpiece frame may be repositionable and relocatable on the tool base in at least two different orientations to support the thin-walled three-dimensional workpiece in the at least two different orientations relative to the first axis during modification of the thin-walled three-dimensional workpiece so that different sides of the thin-walled three-dimensional workpiece are modified without requiring removal of the thin-walled three-dimensional workpiece from the workpiece frame. The workpiece frame includes a body and a workpiece locator.

In some embodiments, the body may be configured to be coupled to the tool base and may define a workpiece-receiving space therein. The workpiece locator may extend from the body into the workpiece-receiving space and into contact with a first end of the thin-walled three-dimensional workpiece having a dovetail shape to support and position the thin-walled three-dimensional workpiece relative to the body. The body of the workpiece frame may include a first arm, a second arm spaced apart from the first arm, and a third arm extending between and interconnecting first terminal ends of the first arm and the second arm.

In some embodiments, the workpiece locator may include a clamp and a workpiece locating protrusion. The clamp may extend inwardly from the third arm of the body into the workpiece-receiving space and may be configured to hold the first end of the thin-walled three-dimensional workpiece having the dovetail shape in a stationary position relative to the body of the workpiece frame and locate the thin-walled three-dimensional workpiece relative to the third arm of the body. The workpiece locating protrusion may extend from the second arm of the body toward the clamp and into contact with the first end of the thin-walled three-dimensional workpiece to locate the thin-walled three-dimensional workpiece within the workpiece-receiving space relative to the first arm and the second arm.

In some embodiments, the clamp may include a first clamp plate extending inwardly from the third arm of the body into the workpiece-receiving space and a second clamp plate coupled to the first clamp plate to move between an open position, in which the thin-walled three-dimensional workpiece is free to move out of the workpiece-receiving space, and a clamped position, in which the first end of the thin-walled three-dimensional workpiece is located and securely held between the first clamp plate and the second clamp plate such that the thin-walled three-dimensional workpiece is blocked from moving out of the workpiece-receiving space. The first clamp plate may be integrally formed with the third arm of the body of the workpiece frame. The first clamp plate may be formed to include a groove extending into the first clamp plate away from the second clamp plate along an entirety of a length of the first clamp plate defined between the first arm and the second arm.

In some embodiments, the groove may be formed to include a first surface extending away from the second clamp plate and a second surface coupled to the first surface and extending toward the second clamp plate. The second clamp plate may include a base configured to be coupled with the first clamp plate, a first projection extending away from a first end of the base toward the second surface of the groove of the first clamp plate, and a second projection extending away from a second end of the base opposite the first end toward the third arm of the body. The first end of the thin-walled three-dimensional workpiece may be received in the groove of the first clamp plate so that the second surface of the groove and the first projection of the second clamp plate cooperate with the first end of the thin-walled three-dimensional workpiece having the dovetail shape to block movement of the thin-walled three-dimensional workpiece away from the third arm of the workpiece frame.

In some embodiments, the workpiece frame may further include a workpiece support assembly configured to be removably coupled to the first arm and the second arm of the body of the workpiece frame to extend between and interconnect second terminal ends of the first arm and the second arm opposite the first terminal ends. The workpiece support assembly may include a support arm that extends between the first arm and the second arm of the body of the workpiece frame and a clamp plate configured to be removably coupled with the support arm to locate a second end of the thin-walled three-dimensional workpiece between the support arm and the clamp plate.

In some embodiments, the clamp plate may include a base configured to be coupled with the support arm, a first projection extending away from the base of the clamp plate toward the support arm from a first end of the base of the clamp plate, and a second projection extending away from the base of the clamp plate toward the support arm from a second end of the base of the clamp plate opposite the first end. In response to the clamp plate being coupled with the support arm, a surface of the first projection of the clamp plate may move along with a corresponding surface of the support arm to cause the second projection of the clamp plate to move toward the second end of the thin-walled three-dimensional workpiece and the support arm so that the thin-walled three-dimensional workpiece moves toward the support arm and the second end of the thin-walled three-dimensional workpiece moves into engagement with an engagement surface of the support arm that faces toward the third arm of the body.

In some embodiments, in response to the thin-walled three-dimensional workpiece moving toward the support arm, the first end of the thin-walled three-dimensional workpiece having the dovetail shape may engage the first clamp plate and the second clamp plate of the clamp to block movement of the thin-walled three-dimensional workpiece away from the third arm of the body.

According to another aspect of the present disclosure, a machine tool system may comprise a workpiece, a machine, and a workpiece frame. The machine may be configured to modify the workpiece. The workpiece frame may be repositionable and relocatable on the machine in at least two different orientations to support the workpiece in the at least two different orientations relative to the machine during modification of the workpiece so that different sides of the workpiece are modified without requiring removal of the workpiece from the workpiece frame. The workpiece frame may includes a body and a workpiece locator. The body may be configured to be coupled to the machine and may define a workpiece-receiving space therein. The workpiece locator may extend from the body into the workpiece-receiving space and into contact with a first end of the workpiece having a dovetail shape to support and position the workpiece relative to the body. The body of the workpiece frame may including a first arm, a second arm spaced apart from the first arm, and a third arm extending between and interconnecting terminal ends of the first arm and the second arm.

In some embodiments, the workpiece locator may include a clamp and a workpiece locating protrusion. The clamp may extend inwardly from the third arm of the body into the workpiece-receiving space and may be configured to hold the first end of the workpiece having the dovetail shape and locate the workpiece relative to the third arm of the body. The workpiece locating protrusion may extend from the second arm of the body toward the clamp and into contact with the first end of the workpiece to locate the workpiece relative to the first arm and the second arm.

In some embodiments, the clamp may include a first clamp plate extending inwardly from the third arm of the body into the workpiece-receiving space and a second clamp plate coupled to the first clamp plate to move between an open position, in which the workpiece is free to move out of the workpiece-receiving space, and a clamped position, in which the first end of the workpiece is located and securely held between the first clamp plate and the second clamp plate such that the workpiece is blocked from moving out of the workpiece-receiving space. The first clamp plate may be formed to include a groove extending into the first clamp plate away from the second clamp plate along an entirety of a length of the first clamp plate defined between the first arm and the second arm. The second clamp plate may include a base configured to be coupled with the first clamp plate, a first projection extending away from a first end of the base toward the groove of the first clamp plate, and a second projection extending away from a second end of the base opposite the first end toward the third arm of the body.

In some embodiments, the first end of the workpiece may be received in the groove of the first clamp plate so that an engagement surface of the groove and the first projection of the second clamp plate cooperate with the first end of the workpiece having the dovetail shape to block movement of the workpiece away from the third arm of the workpiece frame.

According to another aspect of the present disclosure, a method of modifying a workpiece may comprise positioning a first end of the workpiece having a dovetail shape in a groove of a first clamp plate of a workpiece frame. The method may comprise aligning a second clamp plate with the first clamp plate and the first end of the workpiece. The method may comprise inserting a fastener through the second clamp plate and the first clamp plate to secure the first end of the workpiece between the first clamp plate and the second clamp plate. The method may comprise positioning the workpiece frame on a machine in a first position so that the workpiece is in a first orientation. The method may comprise applying a first machine operation to the workpiece. The method may comprise removing the workpiece frame from the machine. The method may comprise positioning the workpiece frame on the machine in a second position so that the workpiece is in a second orientation without separating the workpiece from the workpiece frame. The method may comprise applying a second machine operation to the workpiece.

In some embodiments, the workpiece frame may include a body having a first arm, a second arm spaced apart from the first arm, and a third arm extending between and interconnecting terminal ends of the first arm and the second arm. The method may comprise positioning the workpiece relative to the third arm of the body via the first clamp plate and the second clamp plate.

In some embodiments, the method may comprise contacting a workpiece locating protrusion with the first end of the workpiece to position the workpiece relative to the first arm and the second arm of the body. The method may comprise coupling a support arm to the workpiece frame to contact a second end of the workpiece and coupling a clamp plate to the support arm to locate and secure the second end of the workpiece between the clamp plate and the support arm.

In some embodiments, coupling a clamp plate to the support arm may include moving the workpiece toward the support arm via engagement of the clamp plate with the second end of the workpiece so that the second end of the workpiece contacts an engagement surface of the support arm and the first end of the workpiece having the dovetail shape contacts an engagement surface of the groove of the first clamp plate and an engagement surface of the second clamp plate.

These and other features of the present disclosure will become more apparent from the following description of the illustrative embodiments.

### BRIEF DESCRIPTION OF THE DRAWINGS

FIG. 1 is a diagrammatic view of a machine tool system including a workpiece frame removably coupled to a tool base of a machine in a first position, the workpiece frame supports a workpiece thereon in a first orientation relative to a shaft of the machine that modifies a first side of the workpiece by moving along a first axis;

FIG. 2 is a diagrammatic view of the machine tool system of FIG. 1 showing the workpiece frame removably coupled to the tool base of the machine in a second position, the workpiece frame supports the workpiece thereon in a second orientation relative to the shaft of the machine that modifies an edge of the workpiece by moving along the first axis, the workpiece frame allowing for movement of the workpiece between the first and second orientations without requiring removal of the workpiece from the workpiece frame;

FIG. 3 is a perspective view of a portion of the machine tool system of FIG. 1 showing that the workpiece frame includes a C-shaped body that defines a workpiece-receiving space therein, a workpiece locator that extends from the C-shaped body into the workpiece-receiving space to position the workpiece relative to the C-shaped body, and a workpiece support assembly that is removably coupled to the C-shaped body to provide additional support for the workpiece during machining of the workpiece;

FIG. 4 is an exploded front view of the portion of the machine tool system of FIG. 3 showing that the workpiece locator includes a first clamp plate integrally formed with the C-shaped body and a second clamp plate that couples with the first clamp plate to clamp a first end of the workpiece therebetween, and further showing that the workpiece support assembly includes a support arm that removably couples with the C-shaped body and a clamp plate that couples with the support arm to locate a second end of the workpiece therebetween;

FIG. 5 is an exploded back view of the portion of the machine tool system of FIG. 4;

FIG. 6 is a front elevation view of the portion of the machine tool system of FIG. 3 showing that the first clamp plate and the second clamp plate of the workpiece locator hold the first end of the workpiece to position the workpiece relative to a third arm of the C-shaped body and the support arm and the clamp plate of the workpiece support assembly support the second end of the workpiece, and further showing that the workpiece locator includes a workpiece locating protrusion that contacts the first end of the workpiece to position the workpiece relative to first and second arms of the C-shaped body;

FIG. 7 is a back elevation view of the portion of the machine tool system of FIG. 3 showing that fasteners extend through the support arm and the first and second arms of the C-shaped body to couple the support arm to the body and fasteners extend through the clamp plate and the support arm to couple the clamp plate to the support arm;

FIG. 8 is a section view of the portion of the machine tool system of FIG. 3 showing that the first end of the workpiece has a dovetail shape that cooperates with the first and second clamp plates to block movement of the workpiece away from the third arm of the C-shaped body, and further showing that the second end of the workpiece contacts an engagement surface of the support arm and an engagement surface of the clamp plate to secure the second end of the workpiece;

FIG. 9 is an enlarged view of FIG. 8 showing that the second end of the workpiece is secured between the support arm and the clamp plate;

FIG. 10 is an enlarged view of FIG. 8 showing that the first end of the workpiece having the dovetail shape is blocked from moving away from the third arm of the C-shaped body;

FIG. 11 is a front elevation view of the portion of the machine tool system of FIG. 3 with the workpiece support assembly removed; and

FIG. 12 is a perspective view of the workpiece frame coupled to an exemplary tool base.

### DETAILED DESCRIPTION

For the purposes of promoting an understanding of the principles of the disclosure, reference will now be made to a number of illustrative embodiments illustrated in the drawings and specific language will be used to describe the same.

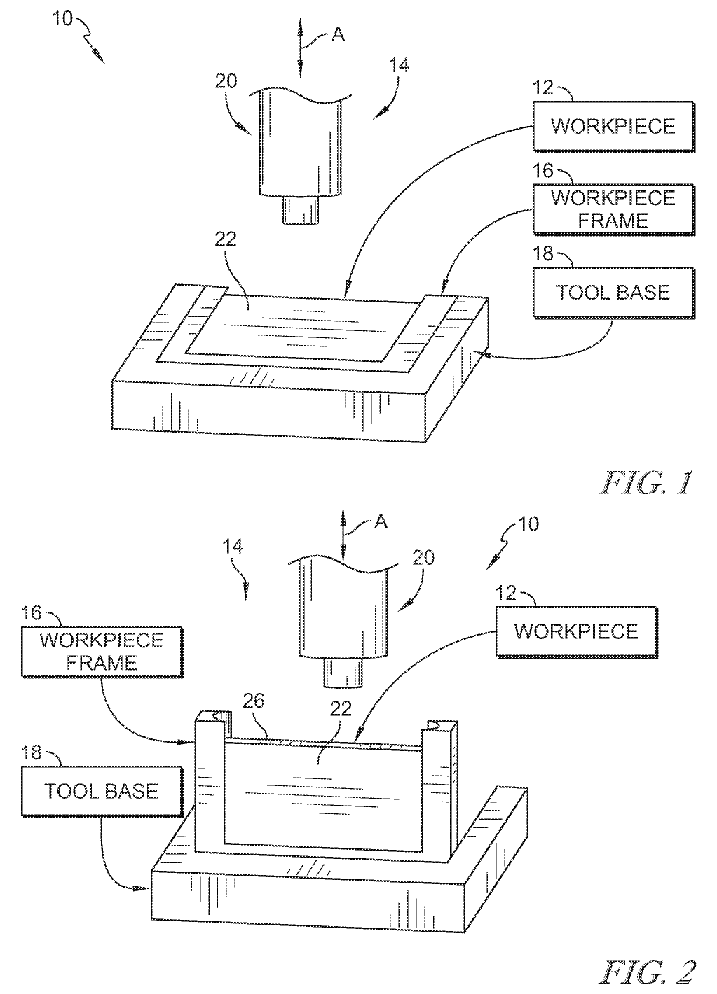

A machine tool system 10 includes a workpiece 12, a machine 14, and a workpiece frame 16, as shown in FIGS. 1 and 2. In illustrative embodiments, the workpiece 12 is a thin-walled three-dimensional workpiece. The machine 14 is configured to modify the workpiece 12. The workpiece frame 16 supports the workpiece 12 and is repositionable and relocatable on the machine 14 in different positions. The workpiece 12 remains stationary relative to the workpiece frame 16 such that repositioning of the workpiece frame 16 on the machine 14 also repositions the workpiece 12 so that different sides of the workpiece 12 may be modified by the machine 14 without requiring removal of the workpiece 12 from the workpiece frame 16.

The machine 14 includes a tool base 18 and a shaft 20, as shown in FIGS. 1 and 2. The tool base 18 supports the workpiece frame 16, and thus, the workpiece 12, relative to the shaft 20. The shaft 20 is spaced apart from the tool base 18 and moves along a first axis A to modify the workpiece 12. The workpiece frame 16 is configured to removably couple with the tool base 18 and is movable between at least a first orientation, as shown in FIG. 1, and a second orientation, as shown in FIG. 2. In the illustrative embodiment shown in FIGS. 1 and 2, the second orientation is offset by about 90 degrees compared to the first orientation. In other embodiments, the second orientation is offset by 180 degrees compared to the first orientation. In other embodiments, the second orientation may be offset from the first orientation by any suitable rotation angle and about any suitable axis through the workpiece frame 16.

In some embodiments, the machine 14 is capable of pulsed electrochemical machining (PECM). In such an embodiment, the shaft 20 or bit attached to the shaft 20 may be referred to as a cathode. To modify the workpiece 12, the shaft 20 moves toward the workpiece 12 and oscillates along the first axis A, but does not contact the workpiece 12. Once the shaft 20 is adjacent the workpiece 12 to form a gap therebetween, an electrolyte is injected into the gap. The electrolyte acts as an electron transfer medium to facilitate anodic dissolution of the material of the workpiece 12 adjacent the shaft 20. In some embodiments, the electrolyte may be a salt-based solution. The electrolyte allows electrical current to flow between the shaft 20 and the workpiece 12. Any by-products, such as, for example, metal hydroxides or hydrogen gas, of the electrochemical process are then flushed away by the electrolyte. The shaft 20 illustratively has a shape inverse to that of the desired workpiece 12 shape. In some embodiments, the shaft 20 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 20 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc.

In some embodiments, the machine 14 is a single axis machine 14. In other words, the shaft 20 of the machine 14 only moves along the first axis A. Thus, to modify different sides of the workpiece 12, the workpiece 12 is repositioned such that the different sides may be modified by the shaft 20 moving along the first axis A. However, the workpiece 12 may be relatively thin and easily distorted or non-repositionable in conventional fixtures and any repositioning of the workpiece 12 itself may distort the workpiece 12. The workpiece frame 16 and the tool base 18 of the present disclosure provides the ability to reposition the workpiece 12 without removal of the workpiece 12 from the workpiece frame 16. In this way, the workpiece frame 16 is repositioned, which also repositions the workpiece 12, while allowing the workpiece 12 to remain stationary relative to the workpiece frame 16.

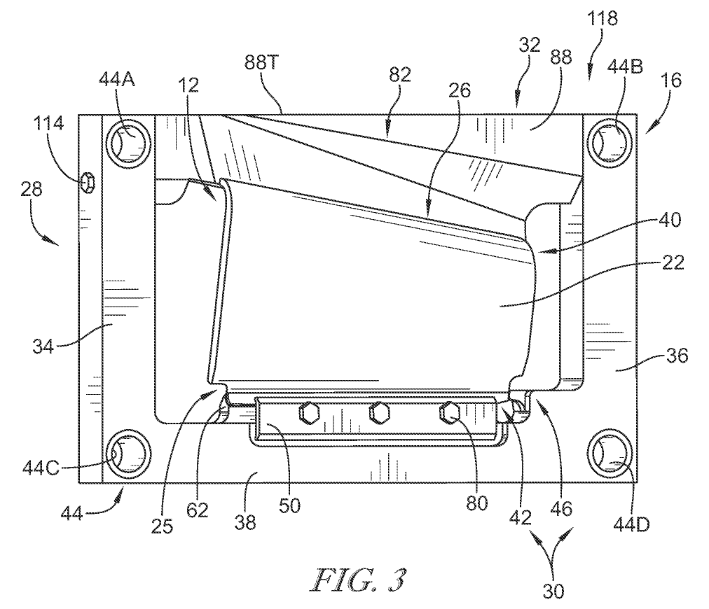

The workpiece 12 is illustratively a thin-walled three-dimensional workpiece, as shown in FIG. 3. The workpiece 12 is three-dimensional, meaning that the workpiece 12 has a length, a width, and a height. The workpiece 12 includes a first side 22, a second side 24 opposite the first side 22, a first end 25 that extends between and interconnects the first side 22 and the second side 24, and a second end 26 opposite the first end 25. The first side 22, the second side 24, and the second end 26 may each be modified by the machine 14 by repositioning the workpiece frame 16, as suggested in FIGS. 1 and 2.

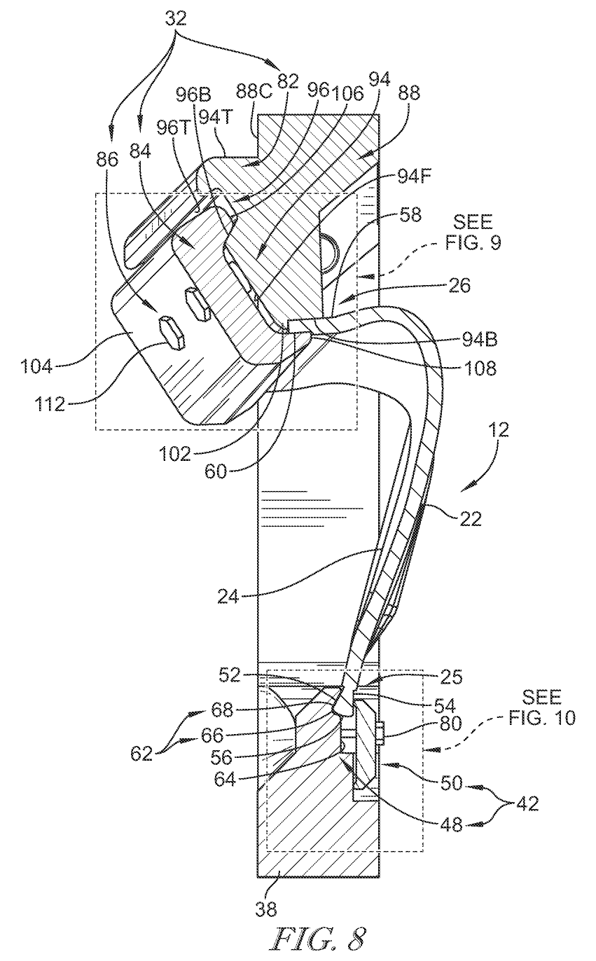

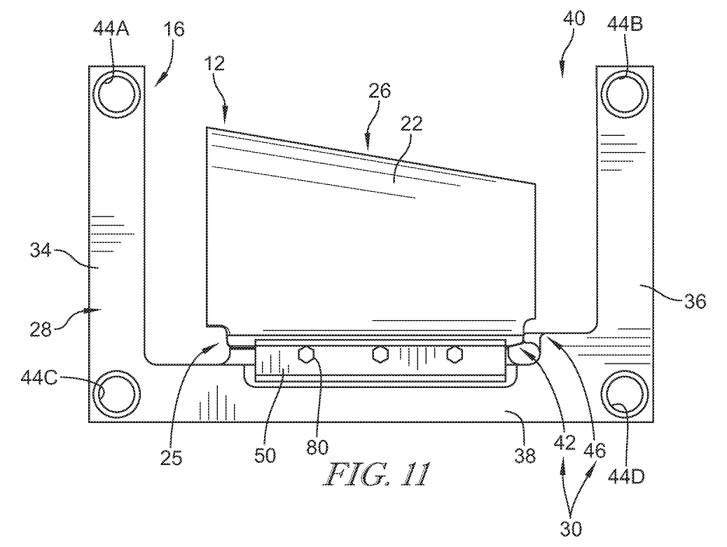

In illustrative embodiments, the first end 25 of the workpiece 12 has a dovetail shape, as shown in FIGS. 8 and 10. The dovetail shape of the first end 25 is defined by converging angled surfaces 52, 54 that are connected by a rounded outer surface 56. The rounded outer surface 56 defines a terminal edge of the first end 25 of the workpiece 12. In other words, the dovetail shape of the first end 25 increases in thickness as the first end 25 extends to the terminal edge of the first end 25 of the workpiece 12. In some embodiments, the first end 25 of the workpiece 12 may have a shape other than a dovetail shape. In some embodiments, the first end 25 of the workpiece 12 may have any suitable shape having an increase in thickness as the first end 25 extends to the terminal edge.

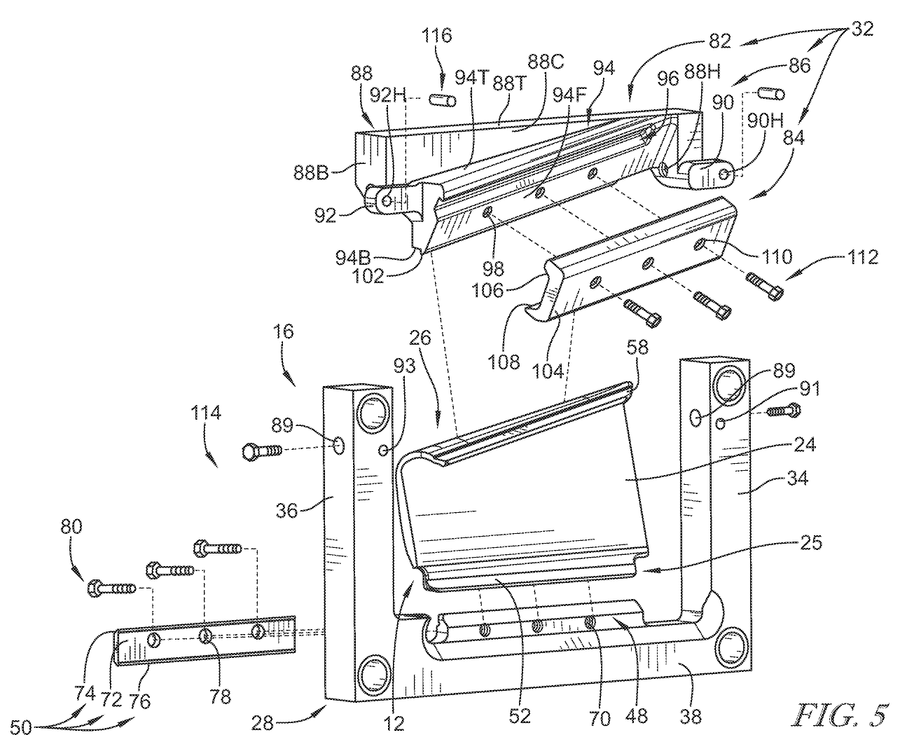

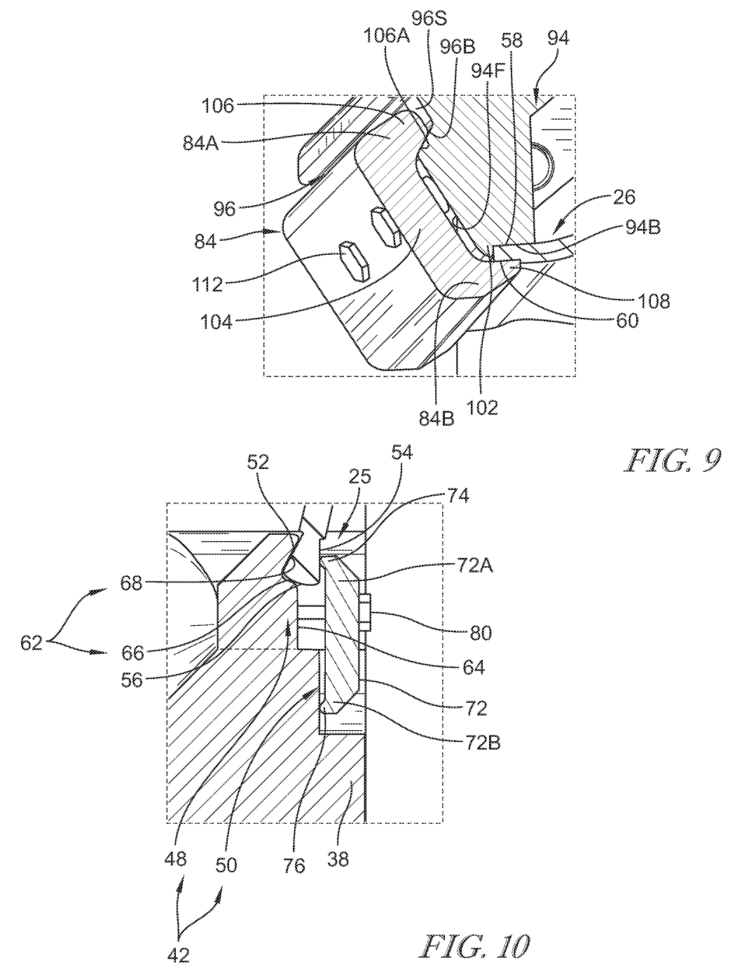

In illustrative embodiments, the second end 26 of the workpiece 12 is formed to define a first shoulder 58 and a second shoulder 60, as shown in FIGS. 5 and 9. The first shoulder 58 and the second shoulder 60 are formed as depressions on opposing sides of the second end 26 of the workpiece 12. The first shoulder 58 extends inwardly into a top side of the second end 26 toward the first end 25 of the workpiece 12. The second shoulder 60 extends inwardly into an opposing bottom side of the second end 26 away from the first end 25 and toward the first shoulder 58.

In some embodiments, the workpiece 12 may be pre-machined prior to being machined by the machine 14. For example, the workpiece 12 may be machined to include the shoulders 58, 60, which act as locating surfaces during the machining of the workpiece 12 with the machine 14.

In some embodiments, the workpiece 12 may be used in a gas turbine engine. For example, the workpiece 12 may form a part of a vane or a blade of a gas turbine engine. The workpiece 12 may provide a coversheet for a pressure side and/or a suction side of a vane or a blade.

In some embodiments, the first end 25 of the workpiece 12 may define a trailing edge of a vane. In such an embodiment, the second end 26 of the workpiece 12 may define a leading edge of the vane, the first side 22 of the workpiece 12 may define a suction side of the vane, and the second side 24 of the workpiece 12 may define a pressure side of the vane.

As shown in FIGS. 1 and 2, the workpiece frame 16 is repositionable and relocatable on the tool base 18 in different positions to support the workpiece 12 in different orientations relative to the first axis A during modification of the workpiece 12 so that different sides of the workpiece 12 are modified without requiring removal of the workpiece 12 from the workpiece frame 16. As shown in FIG. 1, the workpiece frame 16 is in a first position relative to the tool base 18 and the shaft 20. While the workpiece frame 16 is in the first position, the workpiece 12 is in a first orientation relative to the first axis A. In the first orientation of the workpiece 12, the first side 22 of the workpiece 12 is modified. The first orientation of the workpiece 12 may be an orientation with the first side 22 facing upwardly toward the shaft 20.

As shown in FIG. 2, the workpiece frame 16 is in a second position relative to the tool base 18 and the shaft 20. While the workpiece frame 16 is in the second position, the workpiece 12 is in a second orientation relative to the first axis A. In the second orientation of the workpiece 12, the second end 26 of the workpiece 12 is modified. The second orientation of the workpiece 12 may be an orientation with the second end 26 facing upwardly toward the shaft 20.

Though two different positions of the workpiece frame 16 and two different orientations of the workpiece 12 are shown, it will be understood that additional positions and orientations may be used. For example, the workpiece frame 16 may be moved to a third position relative to the tool base 18 and the shaft 20. While the workpiece frame 16 is in the third position, the workpiece 12 is in a third orientation relative to the first axis A. In the third orientation of the workpiece 12, the second side 24 of the workpiece 12 is modified as an example. The third orientation of the workpiece 12 may be an orientation with the second side 24 facing upwardly toward the shaft 20. In other words, the third position may be a flipped position of the first position. To move the workpiece frame 16 between each position, the workpiece frame 16 may be removed from the tool base 18 and reattached to the tool base 18 in a different position.

The workpiece frame 16 includes a body 28, a workpiece locator 30, and a workpiece support assembly 32, as shown in FIGS. 3-5. The body 28 is configured to be coupled to the tool base 18 in the different positions. The workpiece locator 30 contacts the workpiece 12 to position the workpiece 12 relative to the body 28. The workpiece support assembly 32 is removably coupled to the body 28 to provide additional support for the workpiece 12 during machining of the workpiece 12. Precise positioning of the workpiece 12 relative to the body 28 ensures that the workpiece 12 is properly aligned with the shaft 20 in the different orientations of the workpiece 12.

In illustrative embodiments, the body 28 is C-shaped, as shown in FIG. 3. The C-shaped body 28 provides open access to the second end 26 of the workpiece 12 while the workpiece support assembly 32 is not coupled with the body 28, as shown in FIG. 11. This open access allows the machine 14 to more readily modify the workpiece 12. The C-shaped body 28, thus, provides access to three sides of the workpiece 12, including the first side 22, the second side 24, and the second end 26. In some embodiments, the body 28 may not be C-shaped.

The body 28 includes a first arm 34, a second arm 36, and a third arm 38, as shown in FIG. 3. The first arm 34 and the second arm 36 are spaced apart from one another, and the third arm 38 extends between and interconnects first terminal ends of the first arm 34 and the second arm 36. Because the body 28 is C-shaped, second terminal ends of the first arm 34 and the second arm 36 are not interconnected, as shown in FIG. 11. The first arm 34, the second arm 36, and the third arm 38 cooperate to define a workpiece-receiving space 40.

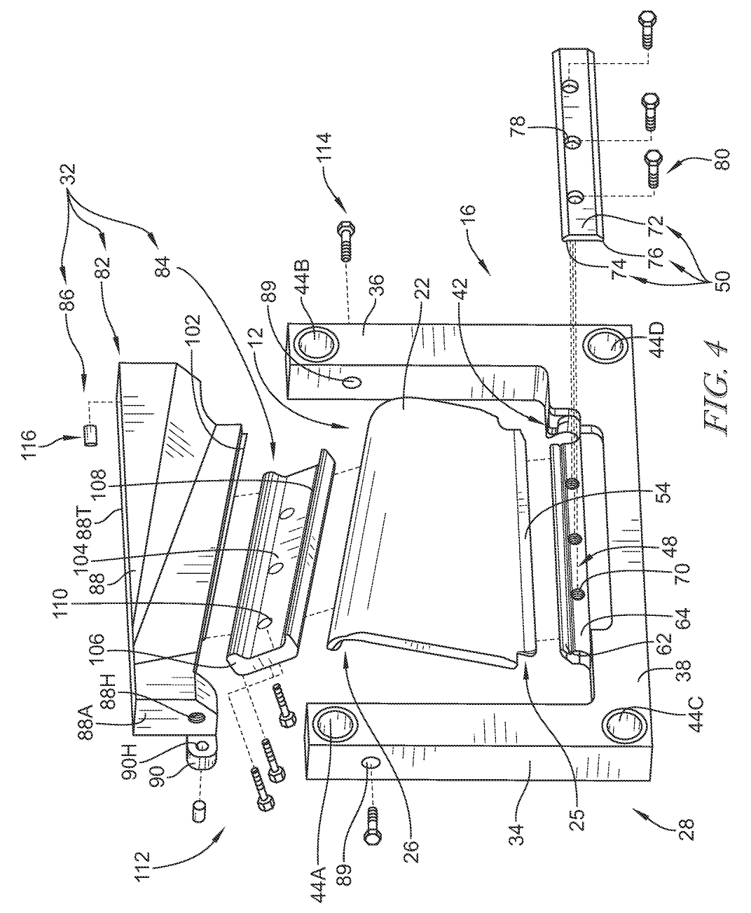

Illustratively, the arms 34, 36, 38 each define planar surfaces, as shown in FIGS. 4 and 5. For example, a front surface of each arm 34,36, 38, as shown in FIG. 4, is substantially planar. As another example, a back surface of each arm 34, 36, 38, as shown in FIG. 5, is substantially planar. The substantially planar surfaces act as primary datums for positioning the workpiece frame 16 in the tool base 18, as shown in FIG. 11. The primary datums ensure proper alignment of the body 28 with the tool base 18.

The workpiece locator 30 includes a clamp 42 and at least one workpiece locating protrusion 46, as shown in FIGS. 3-5. The clamp 42 is coupled to the body 28 and extends into the workpiece-receiving space 40 to couple with the workpiece 12. The at least one workpiece locating protrusion 46 extends into the workpiece-receiving space 40 from the body 28 to contact and locate the workpiece 12.

The clamp 42 illustratively includes a first clamp plate 48 and a second clamp plate 50 spaced apart from the first clamp plate 48, as shown in FIGS. 3-5. The first clamp plate 48 extends inwardly from the third arm 38 of the body 28. The clamp plates 48, 50 are spaced apart from one another to locate the first end 25 of the workpiece 12 between the first clamp plate 48 and the second clamp plate 50. In some embodiments, the third arm 38 is formed to define a recess 38A that receives a portion of the second clamp plate 50 therein. In this way, the second clamp plate 50 does not extend beyond the front surface of third arm 38, as shown in FIG. 10.

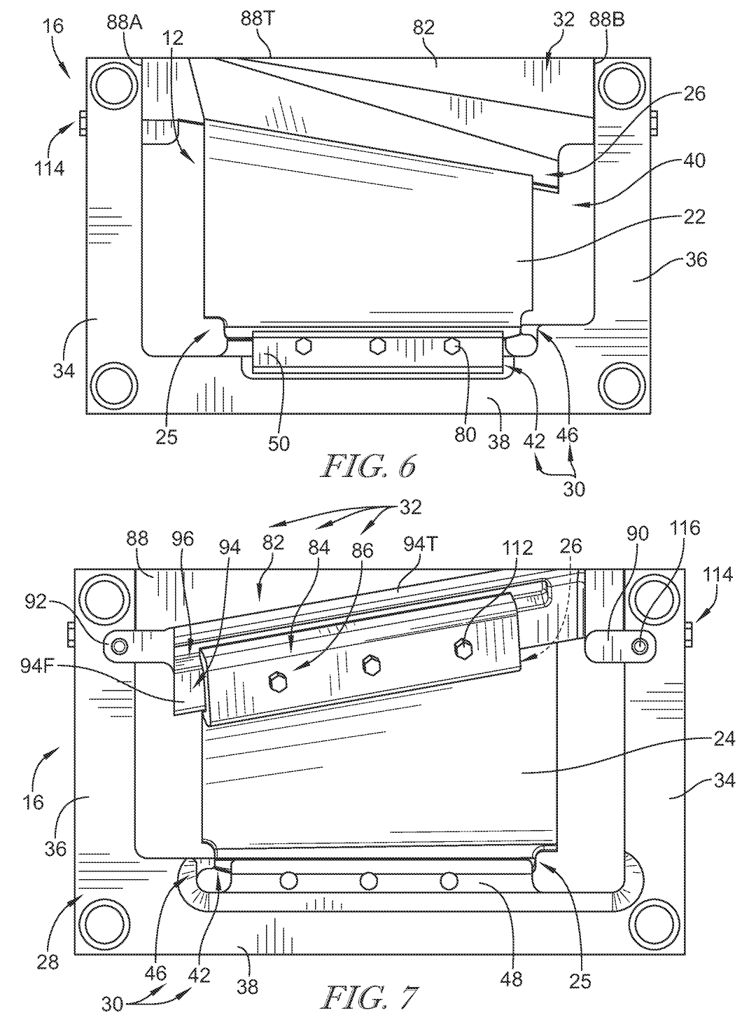

The first clamp plate 48 and the second clamp plate 50 cooperate to hold the workpiece 12 in a stationary position relative to the body 28, as suggested in FIGS. 6 and 7. The first arm 34, the second arm 36, the third arm 38, and the first clamp plate 48 are integrally formed as a single one-piece component, as shown in FIG. 5.

The first clamp plate 48 is formed to define a groove 62 that extends into the first clamp plate 48 from an outwardly-facing surface 64 of the first clamp plate 48, as shown in FIGS. 4, 8, and 10. The first clamp plate 48 is also formed to include at least one through hole 70 extending through the first clamp plate 48. The at least one through hole 70 is located between the groove 62 and the third arm 38 of the body 28.

The groove 62 extends into the first clamp plate 48 along an entirety of a length of the first clamp plate 48 defined between the first arm 34 and the second arm 36, as shown in FIG. 4. The groove 62 is formed to include a first surface 66 extending into the first clamp plate 48 from the outwardly-facing surface 64 and a second surface 68 coupled to the first surface 66 and extending to the outwardly-facing surface 64. The first surface 66 illustratively extends away from the second clamp plate 50, and the second surface 68 extends toward the second clamp plate 50. The outwardly-facing surface 64 of the first clamp plate 48 is substantially planar and flat, and the first surface 66 and the second surface 68 of the groove 62 are angled relative to the outwardly-facing surface 64. The first surface 66 and the second surface 68 cooperate to define an acute angle therebetween.

While the workpiece 12 is positioned in the workpiece-receiving space 40, the first angled surface 52 of the first end 25 of the workpiece 12 contacts and engages the second surface 68 of the groove 62, as shown in FIG. 10. In some embodiments, the rounded outer surface 56 of the first end 25 may contact and engage the first surface 66 of the groove 62.

In some embodiments, the at least one through hole 70 of the first clamp plate 48 includes two through holes 70. In some embodiments, the at least one through hole 70 of the first clamp plate 48 includes three through holes 70, as shown in FIG. 4. Though shown with three through holes 70, any number of through holes 70 may extend through the first clamp plate 48. The at least one through hole 70 is illustratively threaded, as shown in FIGS. 4 and 5.

The second clamp plate 50 moves between an open position, as shown in FIGS. 4 and 5, and a clamped position, as shown in FIG. 3. While in the open position, the workpiece 12 is free for movement out of or within the workpiece-receiving space 40. While in the clamped position, the first end 25 of the workpiece 12 is located and securely held between the first clamp plate 48 and the second clamp plate 50 such that the workpiece 12 is blocked from moving out of the workpiece-receiving space 40.

In some embodiments, the second clamp plate 50 is removable from the first clamp plate 48, as suggested in FIGS. 4 and 5. In such an embodiment, the second clamp plate 50 may be removed from the first clamp plate 48 to remove the workpiece 12 from the workpiece frame 16. In other embodiments, the second clamp plate 50 may be pivotably coupled to the first clamp plate 48 or the third arm 38 to allow the second clamp plate 50 to move relative to the first clamp plate 48 while remaining attached to the workpiece frame 16.

The second clamp plate 50 includes a base 72, a first projection 74, and a second projection 76, as shown in FIGS. 4, 5, and 10. The base 72 is formed to include at least one through hole 78 that aligns with the at least one through hole 70 of the first clamp plate 48. While the second clamp plate 50 is in the clamped position, at least one fastener 80 extends through the at least one through holes 70, 78 of the clamp plates 48, 50 to couple the second clamp plate 50 to the first clamp plate 48. The at least one fastener 80 may be tightened or loosened to move the second clamp plate 50 toward or away from the first clamp plate 48 to securely hold the workpiece 12 between the clamp plates 48, 50 and to remove the workpiece 12 from between the clamp plates 48, 50. The at least one fastener 80 may be screwed into the at least one through holes 70, 78 so that threads of the at least one fastener 80 mate with threads of the at least one through hole 70.

In some embodiments, the at least one through hole 78 of the second clamp plate 50 includes two through holes 78. In some embodiments, the at least one through hole 78 of the second clamp plate 50 includes three through holes 78, as shown in FIGS. 4 and 5. Though shown with three through holes 78, any number of through holes 78 may extend through the second clamp plate 50.

The first projection 74 of the second clamp plate 50 extends away from a first end 72A of the base 72, as shown in FIG. 10. The first projection 74 extends toward the second surface 68 of the groove 62 of the first clamp plate 48. The second projection 76 of the second clamp plate 50 extends away from a second end 72B of the base 72 opposite the first end 72A, as shown in FIG. 10. The second projection 76 extends toward the third arm 38 of the body 28.

The first and second projections 74, 76 extend in the same direction away from the base 72, as shown in FIG. 10. While the second clamp plate 50 is in the clamped position, the first projection 74 contacts and engages the second angled surface 54 of the first end 25 of the workpiece 12, and the second projection 76 contacts and engages the third arm 38 of the body 28.

While the second clamp plate 50 is in the clamped position, a distance between the second surface 68 of the groove 62 and the first projection 74 is less than a maximum thickness of the first end 25 of the workpiece 12 having the dovetail shape, as shown in FIG. 10. In this way, the first end 25 is blocked from removal out of the clamp 42. The clamping of the dovetail shaped first end 25 of the workpiece 12 provides for increased electrical power transfer for the PECM process as the dovetail shape increases a surface area of the first end 25 that is in contact with the clamp 42.

The at least one workpiece locating protrusion 46 extends into the workpiece-receiving space 40 from the body 28 to contact the workpiece 12 and to locate the workpiece 12 within the workpiece-receiving space relative 40 to the body 28, as shown in FIGS. 6 and 7. In some embodiments, the at least one workpiece locating protrusion 46 includes one protrusion 46. In some embodiments, the at least one workpiece locating protrusion 46 includes more than one protrusion 46.

The at least one workpiece locating protrusion 46 extends from the second arm 36 of the body 28 into the workpiece-receiving space 40 toward the clamp 42, as shown in FIG. 3. The at least one workpiece locating protrusion 46 contacts the first end 25 of the workpiece 12. The at least one workpiece locating protrusion 46 ensures that the workpiece 12 is properly positioned within the workpiece-receiving space 40 of the body 28 relative to the first and second arms 34, 36 of the body 28. Likewise, the clamp 42 ensures that the workpiece 12 is properly positioned within the workpiece-receiving space 40 relative to the third arm 38 of the body 28. In some embodiments, the at least one workpiece locating protrusion 46 is integrally formed with the body 28.

The workpiece support assembly 32 is removably coupled with the body 28 of the workpiece frame 16, as shown in FIGS. 3 and 11. The workpiece support assembly 32 includes a support arm 82, a clamp plate 84, and a plurality of fasteners 86, as shown in FIGS. 4 and 5. The support arm 82 extends between the first arm 34 and the second arm 36 of the body 28. The clamp plate 84 is removably coupled with the support arm 82 to support the second end 26 of the workpiece 12. The plurality of fasteners 86 couples the clamp plate 84 to the support arm 82 and the support arm 82 to the body 28 of the workpiece frame 16.

The support arm 82 is removably coupled to the first arm 34 and the second arm 36 of the body 28 to extend between and interconnect second terminal ends of the first arm 34 and the second arm 36 opposite the first terminal ends, as shown in FIG. 3. The support arm 82 includes a mount 88, a first leg 90, a second leg 92, and a clamp member 94. The mount 88 extends between the first arm 34 and the second arm 36. The first leg 90 and the second leg 92 extend outwardly from the mount 88 to overlap with the first arm 34 and the second arm 36, respectively. The clamp member 94 also extends outwardly from the mount 88 and is located between the first leg 90 and the second leg 92.

The mount 88 is located between the first arm 34 and the second arm 36, as shown in FIG. 3. While coupled to the body 28 of the workpiece frame 16, a top surface 88T of the mount 88 that faces away from the workpiece 12 is flush with outer surfaces of the first arm 34 and the second arm 36. The mount 88 includes the top surface 88T, a first side surface 88A, a second side surface 88B, and a third side surface 88C. The first and second side surfaces 88A, 88B are located at opposing ends of the mount 88. The top surface 88T and the third side surface 88C extend between and interconnect the first and second side surfaces 88A, 88B. Each of the surfaces 88A, 88B, 88C, 88T are substantially planar and flat.

The mount 88 is formed to include two threaded holes 88H, as shown in FIGS. 4 and 5. One threaded hole 88H extends into the mount 88 from the first side surface 88A, and another threaded hole 88H extends into the mount 88 from the second side surface 88B. Each of the threaded holes 88H aligns with a corresponding hole 89 in the first arm 34 and the second arm 36 that extends entirely through the first arm 34 and the second arm 36. The holes 89 of the first and second arms 34, 36 are perpendicular to the plurality of holes 44, which will be discussed in greater detail below.

The first leg 90 is coupled to the mount 88 to extend outwardly therefrom toward the first arm 34 of the body 28 of the workpiece frame 16, as shown in FIGS. 4 and 7. The first leg 90 extends outwardly from the third side surface 88C of the mount 88 and beyond the first side surface 88A of the mount 88. In this way, the first leg 90 overlaps with and contacts the back surface of the first arm 34, as shown in FIG. 7. The first leg 90 is located adjacent and below the first hole 44A while the workpiece support assembly 32 is coupled to the workpiece frame 16. The first leg 90 is formed to include a hole 90H extending entirely therethrough. The hole 90H is aligned with a corresponding hole 91 formed in the first arm 34 of the body 28. The hole 91 is located below the first hole 44A and extends into the first arm 34 parallel to the first hole 44A. In illustrative embodiments, the hole 91 does not extend entirely through the first arm 34.

The second leg 92 is coupled to the mount 88 to extend outwardly therefrom toward the second arm 36 of the body 28 of the workpiece frame 16, as shown in FIGS. 5 and 7. The second leg 92 extends outwardly from the mount 88 beyond the second side surface 88B of the mount 88. In this way, the second leg 92 overlaps with and contacts the back surface of the second arm 36, as shown in FIG. 7. The second leg 92 is located adjacent and below the second hole 44B of the second arm 36 while the workpiece support assembly 32 is coupled to the workpiece frame 16. The second leg 92 is formed to include a hole 92H extending entirely therethrough. The hole 92H is aligned with a corresponding hole 93 formed in the second arm 36 of the body 28. The hole 93 is located below the second hole 44B and extends into the second arm 36 parallel to the second hole 44B. In some embodiments, the hole 93 does not extend entirely through the second arm 36.

The clamp member 94 extends outwardly from the third side surface 88C of the mount 88, as shown in FIGS. 5 and 8. The clamp member 94 is configured to couple with the clamp plate 84. The clamp member 94 includes a top surface 94T that extends outwardly away from the third side surface 88C of the mount 88, a front surface 94F that extends downwardly from the top surface 94T toward the third arm 38 of the body 28 of the workpiece frame 16, and a bottom surface 94B that extends away from the front surface 94F. In some embodiments, the top surface 94T is not parallel to the top surface 88T of the mount 88 (i.e., the top surface 94T is angled relative to the top surface 88T). In other words, a distance between the top surface 88T and the top surface 94T adjacent the second leg 92 is greater than a distance between the top surface 88T and the top surface 94T adjacent the first leg 90.

The front surface 94F is angled relative to the top surface 94T of the clamp member 94, as shown in FIG. 8. In some embodiments, an acute angle is formed between the front surface 94F and the top surface 94T. The front surface 94F is formed to include a recess 96 and at least one hole 98, as shown in FIG. 5. The recess 96 extends into the clamp member 94 from the front surface 94F toward the mount 88. The at least one hole 98 extends into the clamp member 94 from the front surface 94F.

The recess 96 defines a top surface 96T, a bottom surface 96B, and a side surface 96S extending between and interconnecting the top surface 96T and the bottom surface 96B, as shown in FIGS. 8 and 9. The side surface 96S is illustratively parallel to the front surface 94F of the clamp member 94. The bottom surface 96B is angled relative to the front surface 94F so as to form an obtuse angle between the front surface 94F and the bottom surface 96B.

The bottom surface 96B of the recess 96 and the front surface 94F of the clamp member 94 are both angled relative to the arms 34, 36, 38 of the body 28 of the workpiece frame 16, as shown in FIG. 8. For example, a plane extending along the bottom surface 96B of the recess 96 is angled relative to a plane extending along the back surface of the arms 34, 36, 38, and a plane extending along the front surface 94F of the clamp member 94 is angled relative to the plane extending along the back surface of the arms 34, 36, 38.

In some embodiments, the at least one hole 98 of the clamp member 94 includes two holes 98. In some embodiments, the at least one hole 98 of the clamp member 94 includes three holes 98, as shown in FIG. 5. Though shown with three holes 98, any number of holes 98 may extend into the clamp member 94. The at least one hole 98 is illustratively threaded, as suggested in FIG. 5. The at least one hole 98 extends into the clamp member 94 substantially orthogonal to the front surface 94F of the clamp member 94 and angled relative to the plane extending along the back surface of the arms 34, 36, 38.

The clamp member 94 is further formed to include a lip 102 that extends outwardly from the bottom surface 94B of the clamp member 94 toward the third arm 38 of the body 28 of the workpiece frame 16, as shown in FIGS. 5 and 9. The lip 102 extends outwardly from the bottom surface 94B at the front surface 94F of the clamp member 94. The mount 88, the first leg 90, the second leg 92, and the clamp member 94 are integrally formed as a single one-piece component.

The clamp plate 84 of the workpiece support assembly 32 is located adjacent the clamp member 94 of the support arm 82 to locate the second end 26 of the workpiece 12 between the clamp plate 84 and the clamp member 94, as shown in FIGS. 7 and 8. The clamp plate 84 and the clamp member 94 cooperate to support the second end 26 of the workpiece 12. In this way, the workpiece support assembly 32 provides improved workpiece 12 rigidity, which improves repeatability and accuracy of machining.

The clamp plate 84 is removable from the clamp member 94, as suggested in FIGS. 4 and 5. The clamp plate 84 includes a base 104, a first projection 106, and a second projection 108, as shown in FIGS. 5, 8, and 9. The base 104 is formed to include at least one through hole 110 that aligns with the at least one hole 98 of the clamp member 94. While clamp plate 84 is coupled to the clamp member 94, at least one clamp fastener 112 extends through the at least one through hole 110 and into the at least one hole 98 to couple the clamp plate 84 to the clamp member 94. The at least one clamp fastener 112 may be tightened or loosened to move the clamp plate 84 toward or away from the clamp member 94 to securely hold the workpiece 12 between the clamp plate 84 and the clamp member 94.

In some embodiments, the at least one through hole 110 of the clamp plate 84 includes two through holes 110. In some embodiments, the at least one through hole 110 of the clamp plate 84 includes three through holes 110, as shown in FIG. 5. Though shown with three through holes 110, any number of through holes 110 may extend through the clamp plate 84. The at least one clamp fastener 112 may be screwed through the at least one through hole 110 and into the at least one hole 98 so that threads of the at least one clamp fastener 112 mate with threads of the at least one hole 98.

The first projection 106 of the clamp plate 84 extends away from a first end 84A of the base 104, as shown in FIG. 9. The first projection 106 extends toward the recess 96 of the clamp member 94. The second projection 108 of the clamp plate 84 extends away from a second end 84B of the base 104 opposite the first end 84A, as shown in FIG. 9. The first and second projections 106, 108 extend in the same direction away from the base 104. The first and second projections 106, 108 and the base 104 cooperate to define a support arm channel sized to receive a portion of the clamp member 94 of the support arm 82 therein.

While the clamp plate 84 is coupled to the clamp member 94, the first shoulder 58 of the second end 26 of the workpiece 12 contacts and engages the bottom surface 94B of the clamp member 94, as suggested in FIG. 5. In some embodiments, the lip 102 of the clamp member 94 contacts and engages an edge of the second end 26. The second projection 108 of the clamp plate 84 contacts and engages the second shoulder 60 of the second end 26, as shown in FIG. 9.

While the clamp plate 84 is coupled to the clamp member 94, the first projection 106 contacts and engages the bottom surface 96B of the recess 96, as shown in FIG. 9. More specifically, an angled surface 106A of the first projection 106 that faces toward the clamp member 94 interfaces with the bottom surface 96B. The angled surface 106A and the bottom surface 96B have matching contours such that the angled surface 106A slides along the bottom surface 96B as the clamp plate 84 is tightened with the clamp member 94 via the at least one clamp fastener 112. As the at least one clamp fastener 112 is torqued, the angled surface 106A slides along the bottom surface 96B and the second projection 108 moves upwardly toward the second shoulder 60 thereby securely clamping the second end 26 of the workpiece 12 between the bottom surface 94B of the clamp member 94 and the second projection 108. As the second end 26 of the workpiece 12 is clamped, the workpiece 12 may move upwardly. In doing so, the first end 25 of the workpiece 12 may further engage the second surface 68 of the groove 62 and the first projection 74 of the second clamp plate 50, while remaining clamped between the first and second clamp plates 48, 50 due to the dovetail shape of the first end 25.

Thus, the bottom surface 94B of the clamp member 94 and the clamp 42 act to position the workpiece 12 between the third arm 38 and the workpiece support assembly 32, as suggested in FIG. 3. The lip 102 of the clamp member 94 positions the second end 26 of the workpiece 12 relative to the first end 25 so as to stop or prevent over rotation of the second end 26 relative to the first end 25 within the workpiece-receiving space 40.

The plurality of fasteners 86 includes the at least one clamp fastener 112, at least one arm fastener 114, and at least one locating fastener 116, as shown in FIGS. 4 and 5. The at least one clamp fastener 112 extends through the base 104 of the clamp plate 84 toward the support arm channel and into the clamp member 94 to removably couple the clamp plate 84 to the support arm 82. The at least one arm fastener 114 extends through the first arm 34 of the body 28 and into the support arm 82 to removably couple the support arm 82 to the body 28. The at least one locating fastener 116 extends through the support arm 82 and into the first arm 34 of the body 28.

The at least one clamp fastener 112 may include any number of clamp fasteners 112. In illustrative embodiments, the number of clamp fasteners 112 is equal to the number of holes 98 and the number of through holes 110. The at least one clamp fastener 112 may comprise a screw, a bolt, or any other suitable fastener.

The at least one arm fastener 114 may include any number of arm fasteners 114. In illustrative embodiments, the at least one arm fastener 114 includes two arm fasteners 114, as shown in FIG. 4. One of the arm fasteners 114 extends through the hole 89 of the first arm 34 of the body 28 and into the threaded hole 88H formed in the first side surface 88A of the mount 88. Another of the arm fasteners 114 extends through the hole 89 of the second arm 36 of the body 28 and into the threaded hole 88H formed in the second side surface 88B of the mount 88. The at least one arm fastener 114 is illustratively threaded so as to mate with threads of the threaded hole 88H of the mount 88. The at least one arm fastener 114 secures the support arm 82 to the body 28 of the workpiece frame 16 to prevent movement of the support arm 82 relative to the body 28. The at least one arm fastener 114 may comprise a screw, a bolt, or any other suitable fastener.

The at least one locating fastener 116 may include any number of locating fasteners 116. In illustrative embodiments, the at least one locating fastener 116 includes two locating fasteners 116, as shown in FIG. 5. One of the locating fasteners 116 extends through the hole 90H formed in the first leg 90 of the support arm 82 and into the hole 91 of the first arm 34 of the body 28. Another of the locating fasteners 116 extends through the hole 92H formed in the second leg 92 of the support arm 82 and into the hole 93 of the second arm 36 of the body 28. The at least one locating fastener 116 is illustratively non-threaded. The at least one locating fastener 116 locates and positions the support arm 82 relative to the body 28 of the workpiece frame 16. The at least one locating fastener 116 may comprise a dowel, a pin, or any other suitable fastener.

The at least one locating fastener 116 extends perpendicular to the at least one arm fastener 114, as shown in FIG. 7. The at least one clamp fastener 112 extends at an angle relative to the at least one locating fastener 116 and the at least one arm fastener 114.

The workpiece support assembly 32 may be removed from the workpiece frame 16, as shown in FIG. 11. Removal of the workpiece support assembly 32 allows for more access to the workpiece 12. While the workpiece support assembly 32 is removed, the C-shaped body 28 provides open access to the second end 26 of the workpiece 12, as shown in FIG. 11. This open access allows the machine 14 to more readily modify the workpiece 12. The C-shaped body 28, thus, provides access to three sides of the workpiece 12, including the first side 22, the second side 24, and the second end 26.

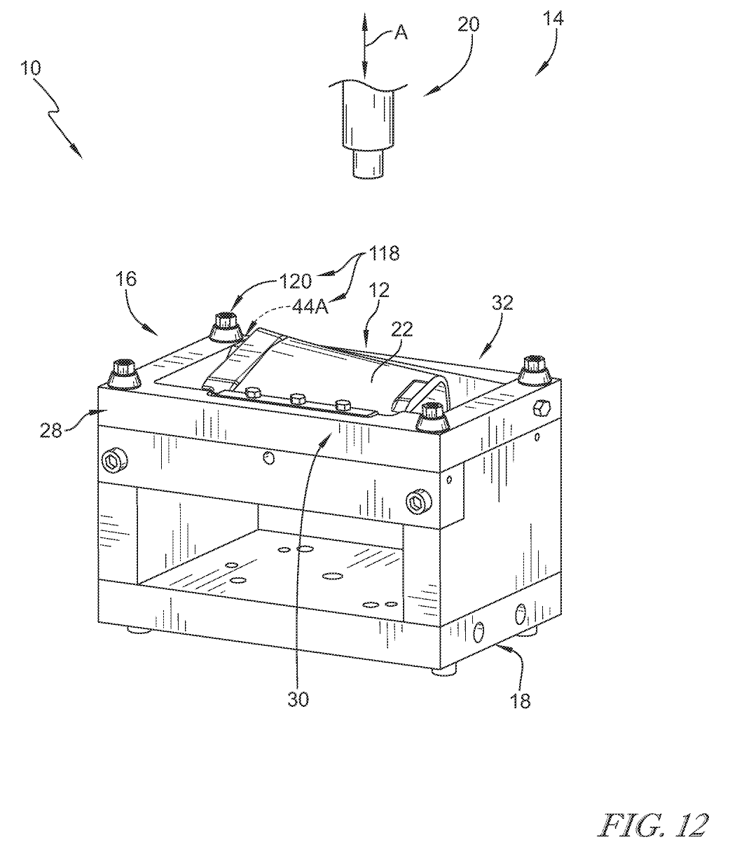

In some embodiments, the workpiece frame 16 further includes a frame locator 118, as shown in FIGS. 3 and 12. The frame locator 118 is located outside of the workpiece-receiving space 40 of the body 28. The frame locator 118 ensures that the body 28 is properly positioned on the tool base 18, thereby ensuring that the workpiece 12 is properly positioned relative to the tool base 18 and the shaft 20.

The frame locator 118 includes a plurality of holes 44 and a plurality of fasteners 120, as shown in FIGS. 3 and 12. The plurality of holes 44 receives the plurality of fasteners 120 therein. The plurality of fasteners 120 is used to position the body 28 relative to the tool base 18. The plurality of fasteners 120 cooperate with the primary datums (the substantially planar surfaces of the arms 34, 36, 38) to help ensure proper alignment of the body 28 with the tool base 18. In some embodiments, the plurality of fasteners 120 is also configured to couple and position the workpiece frame 16 to a flow block. The flow block directs the electrolyte through the gap formed between the workpiece 12 and the shaft 20.

The plurality of holes 44 illustratively includes a first hole 44A, a second hole 44B, a third hole 44C, and a fourth hole 44D, as shown in FIG. 3. Though shown with four holes 44A, 44B, 44C, 44D, additional holes or fewer holes are contemplated. The first hole 44A and the third hole 44C extend through the first arm 34. The second hole 44B and the fourth hole 44D extend through the second arm 36. Each of the plurality of fasteners 120 extends through a corresponding one of the plurality of holes 44 and into a corresponding hole formed in the tool base 18 to secure the workpiece frame 16 to the tool base 18.

An exemplary tool base 18 is shown in FIG. 12. In some embodiments, the tool base 18 is configured to be coupled with a base of the machine 14. The workpiece frame 16, and thus the workpiece 12, may be flipped 180 degrees between a first orientation and a second orientation such that both sides 22, 24 of the workpiece 12 may be modified. When using the exemplary tool base 18, the workpiece 12 is substantially horizontal when coupled with the tool base 18.

In some embodiments, the machine tool system 10 includes additional machines beyond the machine 14. For example, the machine tool system 10 may include the machine 14 capable of PECM and a second machine (not shown) capable of another type of machining. The PECM machine uses the substantially planar surfaces of the arms 34, 36, 38 as primary datums to help gain surface area for power transfer. The second machine includes a tool base, similar to or the same as the tool base 18, and a shaft.

The workpiece support assembly 32 provides increased workpiece 12 support and electrical power transfer for the PECM process. The workpiece support assembly 32 improves workpiece 12 rigidity, which improves repeatability and accuracy of the finish outcome features imparted by the PECM process. When removed, the workpiece support assembly 32 allows tool access and clearance for follow-on operations in other machines.

The workpiece frame 16 is repositionable on the machine 14 and relocatable to the second machine. Thus, the workpiece 12 may be transferred to the second machine without requiring removal of the workpiece 12 from the workpiece frame 16. On the second machine, the workpiece frame 16 may be placed in different positions such that the workpiece 12 is positioned in different orientations. For example, the workpiece frame 16 may be positioned such that the body 28 opens to the right and the workpiece 12 is substantially vertical. As another example, the workpiece frame 16 may be positioned such that the body 28 opens to the left and the workpiece 12 is substantially vertical.

The second machine may be used for hole drilling via laser, cutting via laser, milling of surfaces, and/or cutting via electrical discharge machining (EDM). The second machine may also be used for inspection of the workpiece 12, for example, via non-contact three-dimensional scanning via blue light. The shaft of the second machine may move, similar to the shaft 20, or may remain stationary. The second machine may be a single axis machine or a multi axis machine.

The machine tool system 10 may include any combination of machines. For example, the machine tool system 10 may include the machine 14, the second machine capable of hole drilling via laser, a third machine capable of milling, a fourth machine capable of inspection, etc.

A method of modifying the workpiece 12 is provided herein. The method may comprise pre-machining the workpiece 12 to have locating surfaces, such as the shoulders 58, 60 and the dovetail shaped first end 25. The method may comprise coupling the support arm 82 of the workpiece support assembly 32 to the workpiece frame 16. The method may comprise inserting the at least one locating fastener 116 through the support arm 82 and into the workpiece frame 16. The method may comprise inserting the at least one arm fastener 114 through the workpiece frame 16 and into the support arm 82 to removably couple the support arm 82 to the workpiece frame 16.

The method may comprise positioning the first end 25 of the workpiece 12 having the dovetail shape in the groove 62 of the first clamp plate 48. The method may comprise aligning the second clamp plate 50 with the first clamp plate 48 and the first end 25 of the workpiece 12. The method may comprise inserting the fastener 80 through the second clamp plate 50 and the first clamp plate 48 to secure the first end 25 of the workpiece 12 between the first clamp plate 48 and the second clamp plate 50. The method may comprise positioning the workpiece 12 relative to the third arm 38 via the first clamp plate 48 and the second clamp plate 50. The method may comprise contacting the workpiece locating protrusion 46 with the first end 25 of the workpiece 12 to position the workpiece 12 relative to the first arm 34 and the second arm 36.

The method may comprise coupling the clamp plate 84 of the workpiece support assembly 32 to the support arm 82 to locate the second end 26 of the workpiece 12 between the support arm 82 and the clamp plate 84. Coupling the clamp plate 84 of the workpiece support assembly 32 to the support arm 82 may include moving the angled surface 106A of the first projection 106 of the clamp plate 84 along a corresponding angled bottom surface 94B of the support arm 82 to cause the second projection 108 of the clamp plate 84 to move toward the second end 26 of the workpiece 12 and the support arm 82 to securely position the second end 26 between the second projection 108 and the support arm 82.

The method may comprise inserting the at least one clamp fastener 112 through the clamp plate 84 and into the support arm 82 to removably couple the clamp plate 84 to the support arm 82. The method may comprise positioning the workpiece frame 16 on the machine 14 in a first position so that the workpiece 12 is in a first orientation. The method may comprise applying a first machine operation to the workpiece 12. The method may comprise removing the workpiece frame 16 from the machine 14. The method may comprise removing the clamp plate 84 from the support arm 82. The method may comprise removing the support arm 82 from the workpiece frame 16. The method may comprise positioning the workpiece frame 16 on the machine in a second position so that the workpiece 12 is in a second orientation without separating the workpiece 12 from the workpiece frame 16. The method may comprise applying a second machine operation to the workpiece 12.

The method may comprise torquing the at least one fastener 80 to move the second clamp plate 50 toward the first clamp plate 48 so that the at least one fastener 80 is not fully tightened. The method may then comprise torquing the at least one clamp fastener 112 to move the clamp plate 84 toward the support arm 82 so that the at least one clamp fastener 112 is not fully tightened. The method may then comprise continuing to torque the at least one fastener 80 to move the second clamp plate 50 toward the first clamp plate 48, and continuing to torque the at least one clamp fastener 112 to move the clamp plate 84 toward the support arm 82. In this way, the process of securing the first and second ends 25, 26 of the workpiece 12 may occur incrementally.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising:
a thin-walled three-dimensional workpiece,
a machine configured to modify the thin-walled three-dimensional workpiece, the machine including a tool base configured to support the thin-walled three-dimensional workpiece and a shaft spaced apart from the tool base along a first axis and configured to move along the first axis relative to the tool base to modify the thin-walled three-dimensional workpiece, and
a workpiece frame that is repositionable and relocatable on the tool base in at least two different orientations to support the thin-walled three-dimensional workpiece in the at least two different orientations relative to the first axis during modification of the thin-walled three-dimensional workpiece so that different sides of the thin-walled three-dimensional workpiece are modified without requiring removal of the thin-walled three-dimensional workpiece from the workpiece frame,
wherein the workpiece frame includes a body configured to be coupled to the tool base and defining a workpiece-receiving space therein and a workpiece locator that extends from the body into the workpiece-receiving space and into contact with a first end of the thin-walled three-dimensional workpiece having a dovetail shape to support and position the thin-walled three-dimensional workpiece relative to the body, the body of the workpiece frame including a first arm, a second arm spaced apart from the first arm, and a third arm extending between and interconnecting first terminal ends of the first arm and the second arm,
wherein the workpiece locator includes a clamp extending inwardly from the third arm of the body into the workpiece-receiving space that is configured to hold the first end of the thin-walled three-dimensional workpiece having the dovetail shape in a stationary position relative to the body of the workpiece frame and locate the thin-walled three-dimensional workpiece relative to the third arm of the body and a workpiece locating protrusion extending from the second arm of the body toward the clamp and into contact with the first end of the thin-walled three-dimensional workpiece to locate the thin-walled three-dimensional workpiece within the workpiece-receiving space relative to the first arm and the second arm.

2. The machine tool system of claim 1, wherein the clamp includes a first clamp plate extending inwardly from the third arm of the body into the workpiece-receiving space and a second clamp plate coupled to the first clamp plate to move between an open position, in which the thin-walled three-dimensional workpiece is free to move out of the workpiece-receiving space, and a clamped position, in which the first end of the thin-walled three-dimensional workpiece is located and securely held between the first clamp plate and the second clamp plate such that the thin-walled three-dimensional workpiece is blocked from moving out of the workpiece-receiving space.

3. The machine tool system of claim 2, wherein the first clamp plate is integrally formed with the third arm of the body of the workpiece frame, and wherein the first clamp plate is formed to include a groove extending into the first clamp plate away from the second clamp plate along an entirety of a length of the first clamp plate defined between the first arm and the second arm.

4. The machine tool system of claim 3, wherein the groove is formed to include a first surface extending away from the second clamp plate and a second surface coupled to the first surface and extending toward the second clamp plate.

5. The machine tool system of claim 4, wherein the second clamp plate includes a base configured to be coupled with the first clamp plate, a first projection extending away from a first end of the base toward the second surface of the groove of the first clamp plate, and a second projection extending away from a second end of the base opposite the first end toward the third arm of the body.

6. The machine tool system of claim 5, wherein the first end of the thin-walled three-dimensional workpiece is received in the groove of the first clamp plate so that the second surface of the groove and the first projection of the second clamp plate cooperate with the first end of the thin-walled three-dimensional workpiece having the dovetail shape to block movement of the thin-walled three-dimensional workpiece away from the third arm of the workpiece frame.

7. The machine tool system of claim 2, wherein the workpiece frame further includes a workpiece support assembly configured to be removably coupled to the first arm and the second arm of the body of the workpiece frame to extend between and interconnect second terminal ends of the first arm and the second arm opposite the first terminal ends.

8. The machine tool system of claim 7, wherein the workpiece support assembly includes a support arm that extends between the first arm and the second arm of the body of the workpiece frame and a clamp plate configured to be removably coupled with the support arm to locate a second end of the thin-walled three-dimensional workpiece between the support arm and the clamp plate.

9. The machine tool system of claim 8, wherein the clamp plate includes a base configured to be coupled with the support arm, a first projection extending away from the base of the clamp plate toward the support arm from a first end of the base of the clamp plate, and a second projection extending away from the base of the clamp plate toward the support arm from a second end of the base of the clamp plate opposite the first end.

10. The machine tool system of claim 9, wherein, in response to the clamp plate being coupled with the support arm, a surface of the first projection of the clamp plate moves along with a corresponding surface of the support arm to cause the second projection of the clamp plate to move toward the second end of the thin-walled three-dimensional workpiece and the support arm so that the thin-walled three-dimensional workpiece moves toward the support arm and the second end of the thin-walled three-dimensional workpiece moves into engagement with an engagement surface of the support arm that faces toward the third arm of the body.

11. The machine tool system of claim 10, wherein, in response to the thin-walled three-dimensional workpiece moving toward the support arm, the first end of the thin-walled three-dimensional workpiece having the dovetail shape engages the first clamp plate and the second clamp plate of the clamp to block movement of the thin-walled three-dimensional workpiece away from the third arm of the body.

12. A machine tool system comprising:
a workpiece,
a machine configured to modify the workpiece, and
a workpiece frame that is repositionable and relocatable on the machine in at least two different orientations to support the workpiece in the at least two different orientations relative to the machine during modification of the workpiece so that different sides of the workpiece are modified without requiring removal of the workpiece from the workpiece frame,
wherein the workpiece frame includes a body configured to be coupled to the machine and defining a workpiece-receiving space therein and a workpiece locator that extends from the body into the workpiece-receiving space and into contact with a first end of the workpiece having a dovetail shape to support and position the workpiece relative to the body, the body of the workpiece frame including a first arm, a second arm spaced apart from the first arm, and a third arm extending between and interconnecting terminal ends of the first arm and the second arm,
wherein the workpiece locator includes a clamp extending inwardly from the third arm of the body into the workpiece-receiving space that is configured to hold the first end of the workpiece having the dovetail shape and locate the workpiece relative to the third arm of the body and a workpiece locating protrusion extending from the second arm of the body toward the clamp and into contact with the first end of the workpiece to locate the workpiece relative to the first arm and the second arm.

13. The machine tool system of claim 12, wherein the clamp includes a first clamp plate extending inwardly from the third arm of the body into the workpiece-receiving space and a second clamp plate coupled to the first clamp plate to move between an open position, in which the workpiece is free to move out of the workpiece-receiving space, and a clamped position, in which the first end of the workpiece is located and securely held between the first clamp plate and the second clamp plate such that the workpiece is blocked from moving out of the workpiece-receiving space.

14. The machine tool system of claim 13, wherein the first clamp plate is formed to include a groove extending into the first clamp plate away from the second clamp plate along an entirety of a length of the first clamp plate defined between the first arm and the second arm, and wherein the second clamp plate includes a base configured to be coupled with the first clamp plate, a first projection extending away from a first end of the base toward the groove of the first clamp plate, and a second projection extending away from a second end of the base opposite the first end toward the third arm of the body.

15. The machine tool system of claim 14, wherein the first end of the workpiece is received in the groove of the first clamp plate so that an engagement surface of the groove and the first projection of the second clamp plate cooperate with the first end of the workpiece having the dovetail shape to block movement of the workpiece away from the third arm of the workpiece frame.

16. A method of modifying a workpiece, the method comprising:
positioning a first end of the workpiece having a dovetail shape in a groove of a first clamp plate of a workpiece frame,
aligning a second clamp plate with the first clamp plate and the first end of the workpiece,
inserting a fastener through the second clamp plate and the first clamp plate to secure the first end of the workpiece between the first clamp plate and the second clamp plate,
positioning the workpiece frame on a machine in a first position so that the workpiece is in a first orientation,
applying a first machine operation to the workpiece,
removing the workpiece frame from the machine,
positioning the workpiece frame on the machine in a second position so that the workpiece is in a second orientation without separating the workpiece from the workpiece frame,
applying a second machine operation to the workpiece.

17. The method of claim 16, wherein the workpiece frame includes a body having a first arm, a second arm spaced apart from the first arm, and a third arm extending between and interconnecting terminal ends of the first arm and the second arm, and wherein the method further comprises positioning the workpiece relative to the third arm of the body via the first clamp plate and the second clamp plate.

18. The method of claim 17, further comprising contacting a workpiece locating protrusion with the first end of the workpiece to position the workpiece relative to the first arm and the second arm of the body.

19. The method of claim 16, further comprising coupling a support arm to the workpiece frame to contact a second end of the workpiece and coupling a clamp plate to the support arm to locate and secure the second end of the workpiece between the clamp plate and the support arm.

20. The method of claim 19, wherein coupling a clamp plate to the support arm includes moving the workpiece toward the support arm via engagement of the clamp plate with the second end of the workpiece so that the second end of the workpiece contacts an engagement surface of the support arm and the first end of the workpiece having the dovetail shape contacts an engagement surface of the groove of the first clamp plate and an engagement surface of the second clamp plate.
